(19) United States
(12) Patent Application Publication
(10) Pub. No.: US 2011/0002147 A1
(43) Pub. Date: Jan. 6, 2011

(54) SWITCHING POWER SUPPLY APPARATUS AND SEMICONDUCTOR DEVICE FOR SWITCHING POWER SUPPLY REGULATION

(75) Inventor: Minoru FUKUI, Osaka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/823,297

(22) Filed: Jun. 25, 2010

(30) Foreign Application Priority Data
Jul. 2, 2009 (JP) 2009-158293

(51) Int. Cl. H02M 3/335; G05F 1/46

(52) U.S. Cl. 363/21.12; 323/282

(57) ABSTRACT

An off-period adjustment circuit 17 changes an off period of the switching element 2 after a maximum on period according to duration of a period from when the switching element 2 is turned on to when a current flowing through the switching element 2 reaches an overcurrent detection level. With this configuration, an oscillation frequency of the switching element 2 is changed so that a switching power supply can provide output energy independently of change in input voltage. Consequently provided is a less costly switching power supply apparatus and a semiconductor device used for the switching power supply apparatus, with which currents to loads are made uniform among regulation devices without providing different circuit constants according to a range of input voltages.

### BACKGROUND OF THE INVENTION

(1) Field of the Invention

The present invention relates to switching power supply apparatuses and semiconductor devices which regulate output voltages to supply to loads by switching at direct current voltages.

(2) Description of the Related Art

Switching power supply apparatuses have been widely used as power supply units of appliances for common household use, such as home electrical products, for purposes such as improvement of power efficiency by reducing power consumption. A switching power supply apparatus includes a semiconductor device for switching power supply regulation (hereinafter referred to as a regulation device) which regulates (stabilizes) output voltages through switching operation of semiconductors (switching elements such as transistors) (for example, see Patent Reference 1: Japanese Unexamined Patent Application Publication No. 2007-166810).

A conventional regulation device includes an oscillator 111 which controls switching cycles of a switching element 102, a drain current detection circuit 114 which detects drain current so that peak current of the switching element 102 is controlled, a feedback control circuit 118 which detects states of output voltage via a photocoupler or the like so that an on period of the switching element 102 is controlled.

The drain current detection circuit 114 detects a value of current flowing through the switching element 102, which performs switching operation at a cycle predetermined by the oscillator 111. Peak current of the switching element 102 is controlled by a gate driver 113 based on an output signal provided from the drain current detection circuit 114 through a NOR circuit 120 and an RS flip-flop 112. Furthermore, constant voltage control is performed by providing PWM control through which on periods of the switching element 102 is changed depending on a detected state of the output voltage, so that voltage applied to the load is kept constant.

The conventional regulation device is thus configured to keep output voltage of the switching power supply apparatus constant by controlling a drain current of the switching element.

However, there is a problem with a switching power supply apparatus which includes the conventional regulation device is used.

In a switching power supply apparatus which includes the conventional regulation device as shown in FIG. 1, switching operation of the switching element 102 is stopped by the drain current detection circuit 114 of the switching element 102 when current flowing through the switching element 102 reaches a predetermined value. In this case, the slope of the temporal change in the current flowing through the switching element 102 is represented as Vᵢₙ/L, where L is an L value of a transformer (not shown) and Vᵢₙ is an input voltage. In other word, the higher the input voltage Vᵢₙ is, the greater the slope is.

Operation of the drain current detection circuit 114 to stop the operation of switching element 102 involves a certain delay time due to delay times inherent in elements in the circuitry. The peak current of the switching element 102 is thus represented as a product of Vᵢₙ/L and a current value after the certain delay time which has elapsed since when the drain current detection circuit 114 detects drain current having a current value referenced by the drain current detection circuit 114.

The slope of change in the current flowing through the switching element 102 changes depending on input voltage as shown in FIG. 2. Considering the delay time of the operation of stopping the switching of the switching element 102, a high input voltage and a low input voltage result in different peak drain currents, and thus maximum output power of the switching power supply apparatus varies with the input voltage.

In view of this, higher input voltages used in some countries cause high drain voltages, resulting in problems such as increase in ripple voltage at output terminals and increase in loss due to on resistance of switching elements.

In addition, since the change in ripple voltage causes change in output power to loads and loss due to on-resistance increases, higher voltages lead to lower efficiency of switching power supplies and increase in self-heating of switching elements.

It is thus necessary that circuit constants of regulation devices are accordingly adjusted to specifications of switching power supply apparatuses used with input voltages different worldwide, in order to make currents to loads uniform against variations in characteristics of switching power supply apparatuses of the same circuit configuration used worldwide. This makes reduction in cost of switching power supply apparatuses difficult.

### SUMMARY OF THE INVENTION

The present invention, conceived to address the problem with the conventional switching power supply apparatus, provides a semiconductor device for switching power supply regulation and a switching power supply apparatus which includes the semiconductor device, where the semiconductor device makes currents to loads uniform without providing different circuit constants according to a range of input voltages; thereby allowing reduction in cost of regulation devices.

In order to solve this problem, the semiconductor device according to the present invention includes a control circuit which controls a switching power supply apparatus that converts an input direct current voltage into a regulated output direct current voltage, wherein the switching power supply apparatus includes an output voltage detection circuit which detects a change in the output direct current voltage and transmits, to the control circuit, a feedback signal so that the control circuit controls switching operation which a switching element performs by supplying and blocking an input direct current voltage, the control circuit includes:

an oscillator configured to determine a switching oscillation frequency of the switching element; a feedback control circuit which determines, according to the feedback signal transmitted from the output voltage detection circuit, a level of a current to flow through the switching element; a drain current detection circuit which outputs a voltage according to a current flowing through the switching element; a comparator which generates a signal that causes the switching element to be turned off, when the voltage output by the drain current detection circuit reaches one of the level determined by the feedback control circuit and a reference voltage level; and an off-period adjustment circuit which adjusts an off period based on a control signal to be provided to the switching element and an output signal provided from the oscillator, the off period being a period during which the switching element is kept in an off state, and the control circuit changes the switching oscillation frequency by changing the off period of the switching element by causing the off-period adjustment circuit to change a period indicated as an off period of the switching element by a signal generated by the oscillator, according to a time which the current flowing through the switching element has taken to reach an overcurrent detection level after the switching element is kept in the off state during the adjusted off period.

Furthermore, in the semiconductor device, a capacitor of the off-period adjustment circuit may be charged by a constant current source during a period indicated as an on state of the switching element by a gate signal which causes the switching element to operate, the capacitor may hold a voltage while the gate signal indicates an off state of the switching element, a current source may be generated from the voltage, and a period indicated as an off state of the switching element by the gate signal may be changed using a current from the current source.

Furthermore, the off-period adjustment circuit may output an electrical signal according to duration of a period indicated as an on state of the switching element by a gate signal which causes the switching element to operate and a value of a residual current which is a current detected by the drain current detection circuit when the switching element enters the on state, and the oscillator may be configured to, according to the electrical signal, make a period indicated as the off state by the gate signal shorter as the period indicated as the on state by the gate signal is longer and the residual current is smaller, and makes a period indicated as the off state by the gate signal longer as the period indicated as the on state by the gate signal is shorter and the residual current is larger.

Furthermore, the semiconductor device may further include a high-current operation detection circuit which detects a high-current operation performed when the current detected by the drain current detection circuit is larger than a predetermined reference value, wherein the oscillator is configured to fix, regardless of the electrical signal, duration of a period indicated as the off state by the gate signal in the case where the high-current operation detection circuit detects the high-current operation.

Furthermore, the present invention may be implemented not only as such a semiconductor device but also as a switching power supply apparatus which includes the semiconductor device, a switching element which is provided in the semiconductor device and generates input alternating current voltage by switching input direct current voltage, a transformer which transforms the input alternating current voltage generated by the switching element into output alternating current voltage, and a smoothing circuit which converts the output alternating current voltage to output direct current voltage.

The present invention makes it possible to provide a power supply which has output characteristics uniform against input voltages used worldwide by regulating oscillation frequency of a switching element.

Regulation devices thereby provide uniform currents to loads without being provided different circuit constants according to a range of input voltages, and thus cost of switching power supply apparatuses is reduced.

### Further Information About Technical Background to This Application

The disclosure of Japanese Patent Application No. 2009-158293 filed on Jul. 2, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a circuit diagram which illustrates an exemplary configuration of a conventional semiconductor device;

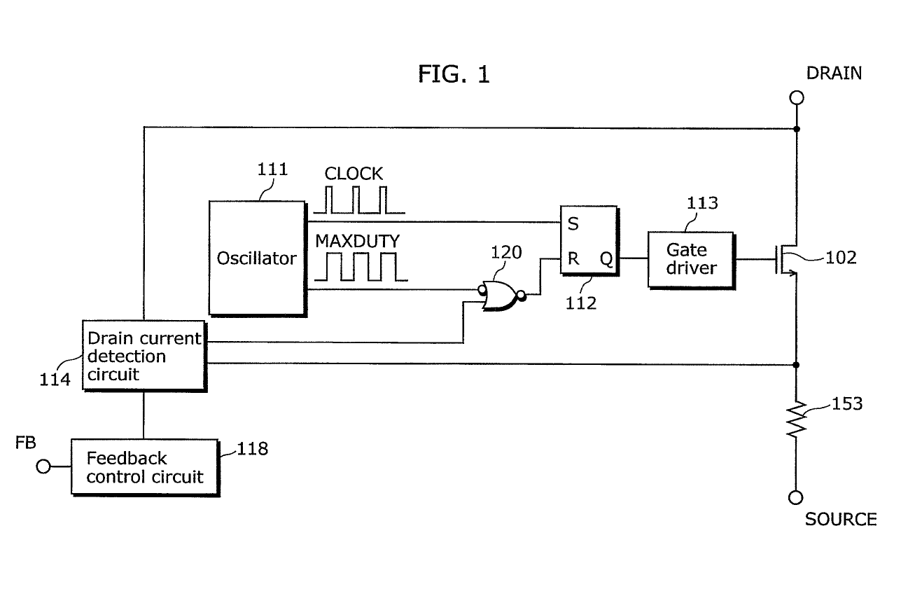

FIG. 2 is a drawing which illustrates currents flowing through a switching element for different input voltages of the conventional semiconductor device;

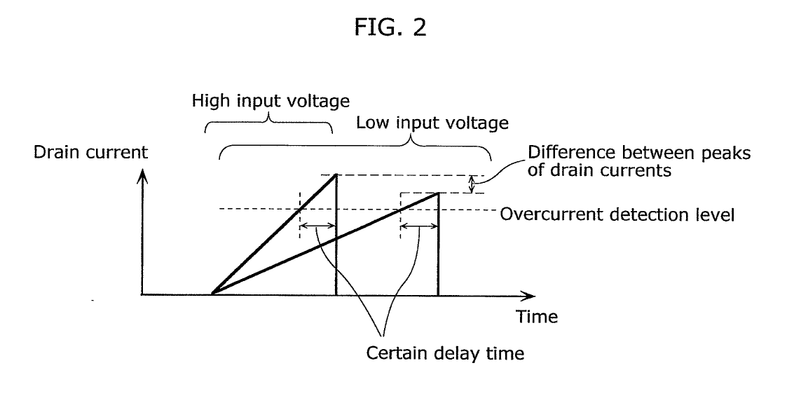

FIG. 3 is a circuit diagram which illustrates an exemplary configuration of a switching power supply apparatus including a semiconductor device according to Embodiment 1 of the present invention;

FIG. 4 is a schematic view which illustrates overcurrent detection levels for feedback currents in the semiconductor device according to Embodiment 1;

FIG. 5 is a circuit diagram which illustrates an exemplary configuration of an off-period adjustment circuit and an oscillator included in the semiconductor device according to Embodiment 1;

FIG. 6 is a drawing which illustrates currents flowing through a switching element for different input voltages of the semiconductor device according to Embodiment 1;

FIG. 7 is a functional block diagram which illustrates an exemplary configuration of a switching power supply apparatus and a semiconductor device for controlling the same according to Embodiment 2 of the present invention;

FIG. 8 is a circuit diagram which illustrates an exemplary configuration of an off-period adjustment circuit and an oscillator included in the semiconductor device according to Embodiment 2;

FIG. 9 is a drawing which illustrates currents flowing through a switching element for different input voltages of the semiconductor device according to Embodiment 2;

FIG. 10 is a circuit diagram which illustrates an exemplary configuration of an off-period adjustment circuit and an oscillator included in a semiconductor device according to Embodiment 3;

FIG. 11 is a drawing which illustrates currents flowing through a switching element for different input voltages of the semiconductor device according to Embodiment 3;

FIG. 12 is a circuit diagram which shows an exemplary configuration of a switching power supply apparatus including a semiconductor device according to Embodiment 4 of the present invention; and

FIG. 13 is a circuit diagram which illustrates an exemplary configuration of an off-period adjustment circuit and an oscillator included in the semiconductor device according to Embodiment 4.

### DESCRIPTION OF THE PREFERRED EMBODIMENTS

The following specifically describes a switching power supply apparatus and a semiconductor device for control of the switching power supply apparatus of the according to embodiments of the present invention with reference to drawings.

### Embodiment 1

The following describes a switching power supply apparatus 100 and a semiconductor device 4 used for control of the switching power supply apparatus 100 according to Embodiment 1 of the present invention.

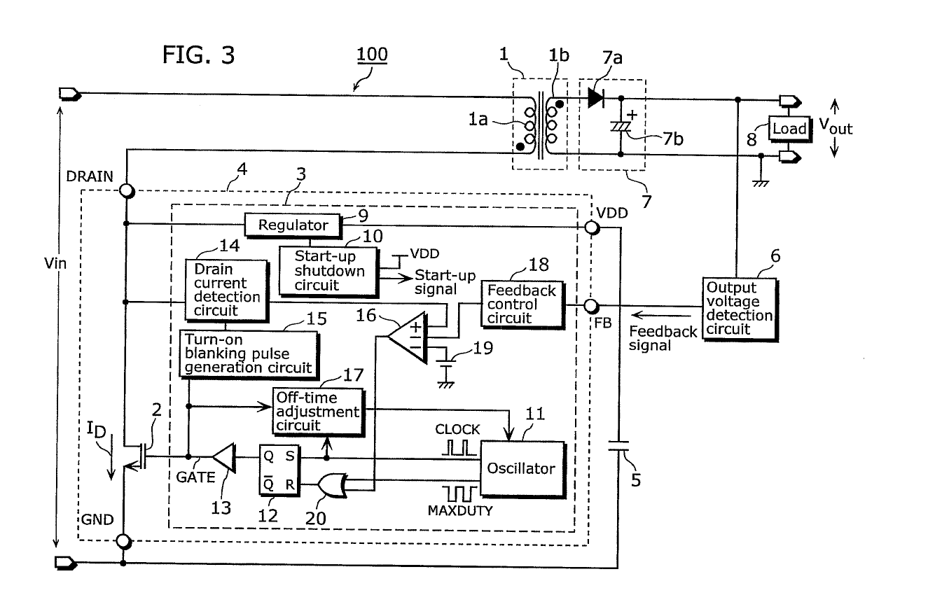

FIG. 3 is a functional block diagram which illustrates an exemplary configuration of the switching power supply apparatus 100 according to Embodiment 1.

In the switching power supply apparatus 100, a transformer 1, which outputs an alternating current voltage resulting from waveform conversion from a direct-current input voltage Vᵢₙ performed through switching operation of the switching element 2, includes a primary winding 1a and a secondary winding 1b. The primary winding 1a and the secondary winding 1b are opposite in polarity. The secondary winding 1b provides alternating current voltage. The alternating current is converted into an output direct current voltage by a smoothing circuit 7 and then supplied to a load 8. The smoothing circuit 7 includes a diode 7a and a capacitor 7b. The switching power supply apparatus 100 is a flyback switching power supply apparatus. The switching element 2 is connected to the primary winding 1a in series. Switching on and off the switching element 2 is controlled according to an output signal provided from a control circuit 3 to a control electrode of the switching element 2.

The semiconductor device 4 includes the control circuit 3 and the switching element 2. The switching element 2, which may be a power MOSFET, and the control circuit 3 are integrated on a single semiconductor substrate.

A DRAIN terminal is a junction point between the primary winding 1a of the transformer 1 and the switching element 2. That is, the DRAIN terminal is a terminal connected to a drain of the switching element 2.

A GND terminal, which is a terminal to connect a source of the switching element 2 and GND of the control circuit 3 to a ground level, is connected to a terminal of a lower potential between two terminals to which input voltages Vᵢₙ are applied.

A VDD terminal, to which a capacitor 5 is connected, is a terminal through which the capacitor 5 is charged by a current from a regulator 9 incorporated in the control circuit 3 in order to control power supply voltage of the control circuit 3.

An FB terminal provides a feedback control circuit 18 of the control circuit 3 with a feedback signal (for example, a current generated by a phototransistor) provided from the output voltage detection circuit 6. The feedback signal indicates a direct-current output voltage V_{out.}

The regulator 9 is connected to the DRAIN terminal of the switching element 2, the VDD terminal, and the start-up shutdown circuit 10. The regulator 9 supplies a current provided from the DRAIN terminal to the capacitor 5 via the VDD terminal to increase an auxiliary power supply voltage VDD when the input voltage Vᵢₙ is applied to the DRAIN terminal of the switching element 2 via the transformer 1. When voltage at the VDD terminal increases to a start-up voltage, the regulator 9 stops supplying the current from the DRAIN terminal to the capacitor 5. When the voltage at the VDD terminal decreases to the start-up voltage or lower again, the regulator 9 starts supplying a current from the DRAIN terminal to the VDD terminal to increase the voltage at the VDD terminal again.

A start-up shutdown circuit 10 monitors the voltage at the VDD terminal and controls start-up and shutdown of switching operation of the switching element 2 (in other words, turns on and off the switching element 2) depending on the magnitude of the voltage at the VDD terminal.

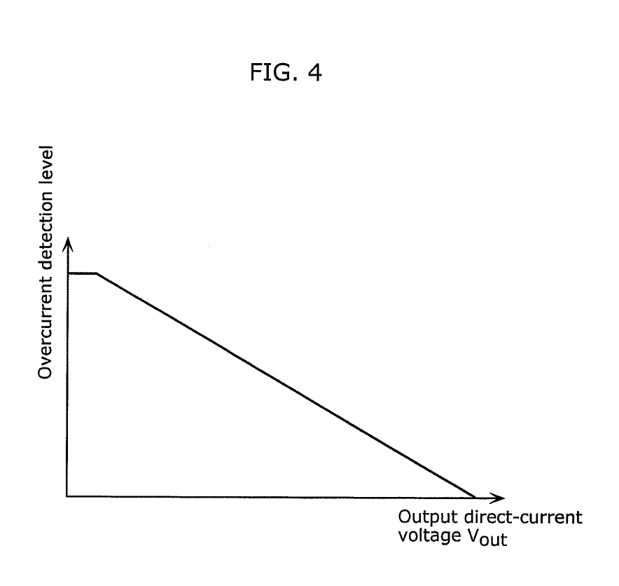

The feedback control circuit 18 determines an overcurrent detection level which indicates an upper limit of the current flowing through the switching element 2 according to the feedback signal provided from the output voltage detection circuit 6 to the FB terminal of the control circuit 3 so that the output voltage Vₒᵤₜ indicated by the feedback signal is stably maintained as shown in FIG. 4. The feedback control circuit 18 then provides an output voltage which indicates the determined overcurrent detection level to a negative input of a comparator 16.

With this configuration, the current flowing through the switching element 2 decreases when the output voltage Vₒᵤₜ increases under a light load, and the current flowing through the switching element 2 increases when the output voltage Vₒᵤₜ decreases under a heavy load.

A drain current detection circuit 14 relatively detects the drain current flowing through the switching element 2 by detecting, for example, an on voltage which is determined as a product of the drain current flowing through the switching element 2 and an on resistance of the switching element 2, and then provides a voltage signal in proportion to the detected drain current to a positive input of the comparator 16.

The comparator 16 outputs a high-level signal when a voltage indicating the drain current provided into the positive input is equal to or larger than a lower one of a voltage of the output signal provided from the feedback control circuit 18 into a first negative input and a reference voltage 19 at a second negative input.

A turn-on blanking pulse generation circuit 15 outputs a blanking pulse for a certain blanking time after the gate driver 13 provides a high-level GATE signal to the switching element 2 in order to prevent the drain current detection circuit 14 from false detection of, for example, a capacitive current spike due to capacitance of the switching element 2.

An off-period adjustment circuit 17 receives an oscillation starting signal from the oscillator 11 and an output signal from the drain current detection circuit 14, and changes an off period of the oscillator 11 depending on on-period duration of switching converted into voltages in order to adjust duration of an off period of the switching element 2. The off-period adjustment circuit 17 and an exemplary circuit configuration thereof will be detailed in description of operation below.

Once the semiconductor device 4 is turned on, an RS flip-flop 12 receives a pulse signal, that is, a CLOCK signal, at a high level from the oscillator 11 into a set input S thereof, and thus an output Q rises to a high level and the GATE signal of the gate driver 13 rises to a high level, so that the switching element 2 enters an on state.

On the other hand, when the switching element 2 has entered the on state and, after a turn-on blanking time, receives a current at an overcurrent detection level, which has been determined according to the feedback signal from the output voltage detection circuit 6, from the feedback control circuit 18, the output signal from the comparator 16 rises to a high level and is provided to a reset input R of the RS flip-flop 12 via an OR circuit 20. The output Q from the RS flip-flop 12 thus falls to a low level and the output of the gate driver 13 falls to a low level, so that the switching element 2 enters an off state.

Alternatively, when the output of the comparator 16 remains at a low level during a maximum on period in which a MAXDUTY signal of the oscillator 11 is at a low level, the MAXDUTY signal of the oscillator 11 inverts to a high level after the maximum on period has elapsed. The MAXDUTY signal at a high level is provided to the reset input R of the RS flip-flop 12 via the OR circuit 20. The output Q of the RS flip-flop 12 thus falls to a low level and the output of the gate driver 13 falls to a low level, so that the switching element 2 is forcibly put into an off state regardless of the amount of the current flowing through the switching element 2.

This is signal processing which causes switching on and off of the switching element 2.

In the transformer 1, the input voltage Vᵢₙ is waveform-converted by the switching operation of the switching element 2, and thus an alternating current voltage is induced in the secondary winding 1b. The secondary winding 1b of the transformer 1 is connected to an output voltage generation unit 7 which includes the diode 7a for rectification and the capacitor 7b. The output voltage generation unit 7 rectifies and smoothes the induced alternating current voltage to generate the direct-current output voltage Vₒᵤₜ to be applied to the load 8.

The output voltage detection circuit 6 includes, for example, an LED and a zener diode. The output voltage detection circuit 6 detects a voltage level of the output voltage Vₒᵤₜ and outputs a feedback signal which is necessary for the control circuit 3 to control switching operation of the switching element 2 so that the output voltage Vₒᵤₜ is stable at a predetermined voltage.

Here, it is assumed that, in the switching power supply apparatus 100, the primary winding 1a of the transformer 1 for power conversion is provided with the direct-current input voltage Vᵢₙ which is prepared from commercial alternating current power through rectification by a rectifier such as a diode bridge and smoothing by an input capacitor.

The following describes operation of the switching power supply apparatus 100 and the semiconductor device 4 used in the switching power supply apparatus 100 shown in FIG. 3 and configured as described above.

The alternating current power sourced from the commercial power supply is rectified by the rectifier such as a diode bridge and smoothed by an input capacitor, which are not shown in the drawings, and then converted into the direct-current input voltage Vᵢₙ. The input voltage Vᵢₙ is applied to the DRAIN terminal via the primary winding 1a of the transformer 1. A start-up charge current then flows from the DRAIN terminal, via the regulator 9 of the control circuit 3, to the capacitor 5 connected to the VDD terminal. When the voltage at the VDD terminal of the control circuit 3 increased by the charge current reaches the start-up voltage set in the start-up shutdown circuit 10, control of the switching operation of the switching element 2 is started.

When the switching element 2 is turned on, a current flows through the switching element 2, and a voltage depending on the magnitude of the current flowing through the switching element 2 is provided from an output of the drain current detection circuit 14 and into the positive input of the comparator 16. In addition, an output voltage according to the feedback signal from the output voltage detection circuit 6 is provided from the feedback control circuit 18 into the first negative input of the comparator 16, and a reference voltage 19 is provided into the second negative input of the comparator 16.

When the output voltage of the drain current detection circuit 14 rises to be equal to or higher than a lower one of the output voltage of the feedback control circuit 18 and the reference voltage 19, a high-level signal is provided from the comparator 16 into the reset input R of the RS flip-flop 12, so that and the switching element 2 is turned off.

There is a delay time between when the output voltage of the drain current detection circuit 14 rises to be equal to or higher than one of the output voltage of the feedback control circuit 18 and the reference voltage 19 and when the switching element 2 is turned off.

When the switching element 2 is turned off, energy stored in the primary winding 1a of the transformer 1 during the on period of the switching element 2 is transferred to the secondary winding 1b.

The output voltage Vₒᵤₜ increases through repetition of the switching operation above. When the output voltage Vₒᵤₜ becomes equal to or higher than a voltage set in the output voltage detection circuit 6, the output voltage of the feedback control circuit 18 decreases depending on the magnitude of the feedback current from the FB terminal of the control circuit 3 provided as a feedback signal from the output voltage detection circuit 6, and thus the voltage at the negative input of the comparator 16 decreases, so that the current flowing through the switching element 2 decreases. This is how the state of on-duty of the switching element 2 becomes appropriate.

In other words, the period of time for which the current flows through the switching element 2 is shorter when the load is light with a small current supply to the load 8, and longer when the load is heavy.

The following describes the off-period adjustment circuit 17 and the oscillator 11 in detail.

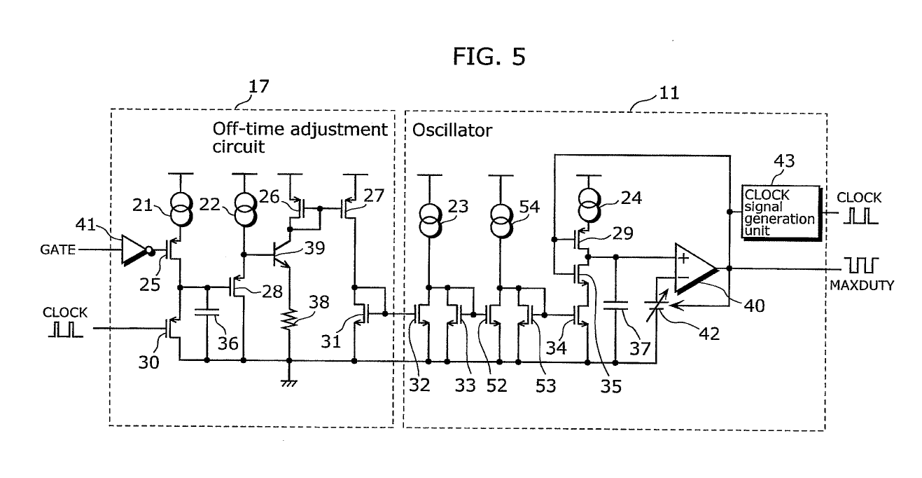

FIG. 5 is a circuit diagram which illustrates an exemplary configuration of the off-period adjustment circuit 17 and the oscillator 11.

In FIG. 5, the off-period adjustment circuit 17 and the oscillator 11 include constant current sources 21, 22, 23, 24, and 54, p-type MOSFETs 25, 26, 27, 28, and 29, n-type MOSFETs 30, 31, 32, 33, 34, 35, 52, and 53, capacitors 36 and 37, a resistor 38, an NPN bipolar transistor 39, a comparator 40, an inverter circuit 41, a reference voltage source 42, and a CLOCK signal generator 43. The pair of the p-type MOSFETs 26 and 27, the pair of the n-type MOSFET 31 and 32, the pair of the n-type MOSFET 33 and 52, and the pair of the n-type MOSFETs 53 and 34 each form a current-mirror circuit.

When the output of the comparator 40 is at a low level, the p-type MOSFET 29 turns on, a current flows from the constant current source 24 into the capacitor 37 to charge the capacitor 37, and then the voltage across the capacitor 37 is provided into a positive input of the comparator 40. The reference voltage source 42 outputs a lower reference voltage and a higher reference voltage for a high-level output and a low-level output of the comparator 40, respectively. This produces a hysteresis of the output of the comparator 40.

Until the voltage across the capacitor 37 reaches the higher reference voltage of the reference voltage source 42, the output of the comparator 40 is at the low level, and thus the MAXDUTY signal is at the low level indicating the maximum on period of the switching element 2.

When the output of the comparator 40 falls to the low level, the CLOCK signal generator 43 differentiates the output of the comparator 40 at an edge of the falling so as to output a CLOCK signal at a high level for a short period.

A CLOCK signal at a high level is provided into the set input S of the RS flip-flop 12, and then the output Q from the RS flip-flop 12 rises to a high level. This causes the GATE signal, which is the output of the gate driver 13, to rise to a high level, so that the switching element 2 is turned on.

The high-level CLOCK signal is also provided into the gate of the n-type MOSFET 30, and then the n-type MOSFET 30 is turned on to cause the voltage of the capacitor 36 to fall to the GND voltage.

When the GATE signal is at the high level, a low-level signal is provided into the gate of the p-type MOSFET 25 through the inverter circuit 41. This turns on the p-type MOSFET 25, and thus a current is provided from the constant current source 21 to the capacitor 36.

The base voltage of the NPN bipolar transistor 39 is equal to the sum of the voltage of the capacitor 36 and a Vₜₕ voltage of the p-type MOSFET 28. A current flowing through the NPN bipolar transistor 39 is determined by a resistance of the resistor 38 and a voltage obtained by subtracting a V_{BE} voltage of the bipolar transistor 39 from the base voltage.

A current flowing through the n-type MOSFET 32 is determined by the current flowing through the NPN bipolar transistor 39, the mirror circuit made up of the p-type MOSFETs 26 and 27 and the mirror circuit made up of the n-type MOSFETs 31 and 32. A current flowing through the n-type MOSFET 33 is decreased by passing a current from the constant current source 23 to the n-type MOSFET 32, and a current flowing through the n-type MOSFET 53 is determined by passing a current from the constant current source 54 to the n-type MOSFET 52 so that the current flowing through the n-type MOSFET 53 increases as the current flowing through the n-type MOSFET 32 increases.

Next, the output of the comparator 16 rises to a high level when the output of the drain current detection circuit 14 rises to be equal to or higher than one of a voltage of the feedback signal from the output voltage detection circuit 6 and the reference voltage 19. A high level signal is then provided into the reset input R of the RS flip-flop 12 causing the output Q of the RS flip-flop 12 to fall to a low level, so that the output of the gate driver 13 falls to a low level.

This turns off the p-type MOSFET 25 and stops a charging current from the constant current source 21 to the capacitor 36. The capacitor 36 holds a voltage which has been increased while the GATE signal is at a high level (that is, during an on period of the switching element 2), and thus a current value of the n-type MOSFET 34 while the n-type MOSFET 35 is on is determined.

When the voltage across the capacitor 37 reaches the higher reference voltage of the reference voltage source 42, the output voltage of the comparator 40 changes to a high level and the MAXDUTY signal changes to a high level indicating an off period. This turns off the p-type MOSFET 29, turns on the n-type MOSFET 35, and thus the voltage of the reference voltage source 42 changes to the lower reference voltage.

The voltage across the capacitor 37 decreases at a rate according to a value of the current flowing through the n-type MOSFET 34. When the voltage across the capacitor 37 becomes equal to or lower than the lower reference voltage, the output from the comparator 40 inverts to a low level, and the MAXDUTY signal returns to the low level indicating the maximum on period of the switching element 2.

Thus, in the switching power supply apparatus 100, a period of each cycle (in other words, a switching frequency) of the switching element 2 is adjusted by changing duration of an off period which follows each on operation of the switching element 2 so as to make the voltage across the capacitor 36 equal to the GND voltage using the CLOCK signal provided from the oscillator 11.

The following describes effects of the operation above.

When the switching element 2 is turned on, charging the capacitor 36 is started. The voltage across the capacitor 36 increases while the switching element 2 is on. After the switching element 2 turns off, the capacitor 36 holds the increased voltage. When the output from the comparator 40 is at a high level indicating an off-period, and the n-type MOSFET 35 is turned on, the current flowing through the n-type MOSFET 34 increases or decreases depending on the voltage held by the capacitor 36, so that the duration of the off period changes which is indicated by the output of the comparator 40 at the high level.

This is expressed by the equations below.

The voltage across the capacitor 36, V₁, is expressed by EQ. 1 in relation to a period from when the switching element 2 is turned on to when the switching element 2 is turned off:

V₁=tₒₙ×I_{const1}/C₁ (EQ. 1),

where
C₁ is a capacity of the capacitor 36;
tₒₙ is a period from when the switching element 2 is turned on to when the switching element 2 is turned off; and
I_{const1} is a current flowing from the constant current source 21.

The value of V₁ is maintained until the CLOCK signal is output after the switching element 2 is turned off.

The current I₁ which flows through the p-type MOSFET 26 is expressed by EQ. 2:

I₁=(V₁+Vₚₜₕ+V_{BE})/R (EQ. 2),

where
Vₚₜₕ is a threshold of the p-type MOSFET 26;
V_{BE} is a voltage between base and emitter terminals of the NPN bipolar transistor 39; and
R is a resistance of the resistor 38.

The current I₂ which flows through the n-type MOSFET 34 is expressed by EQ. 3:

I₂=(I_{const3}−((I_{const2}-I₁×n₁×n₂)×n₃))×n₄ (EQ. 3),

where
I_{const2} is a current flowing from the constant current source 23;
I_{const3} is a current flowing from the constant current source 54;
n₁ is a mirror ratio of the current-mirror circuit made up of the p-type MOSFETs 26 and 27;
n₂ is a mirror ratio of the current-mirror circuit made up of the n-type MOSFETs 31 and 32;
n₃ is a mirror ratio of the current-mirror circuit made up of the n-type MOSFETs 33 and 52; and
n₄ is a mirror ratio of the current-mirror circuit made up of the n-type MOSFETs 53 and 34.

Thus, the voltage V₁ of the capacitor 36 increases as the on period tₒₙ of the switching element 2 becomes longer, so that the current I₁ of the p-type MOSFET 26 increases and the current I₂ of the n-type MOSFET 34 thus increases. Conversely, the current I₂ of the n-type MOSFET 34 decreases as the on period tₒₙ of the switching element 2 becomes shorter.

The duration PW₁ of the maximum on period, which is indicated by the MAXDUTY signal at a low level, is expressed by EQ. 4:

PW₁=ΔV×C₂/I_{const4} (EQ. 4),

where
ΔV is a difference between the two reference voltages of the reference voltage source 42;
C₂ is a capacity of the capacitor 37; and
I_{const4} is a current flowing from the constant current source 24.

The duration PW₂ of the off period, which is indicated by the MAXDUTY signal at a high level, is expressed by EQ. 5:

PW₂=ΔV×C₂/I₂ (EQ. 5),

where
I₂ is a current flowing through the n-type MOSFET 34.

Thus, the off period PW₂ becomes shorter as the on period tₒₙ of the switching element 2 becomes longer. Conversely, the off-period PW₂ becomes longer as the on period tₒₙ becomes shorter.

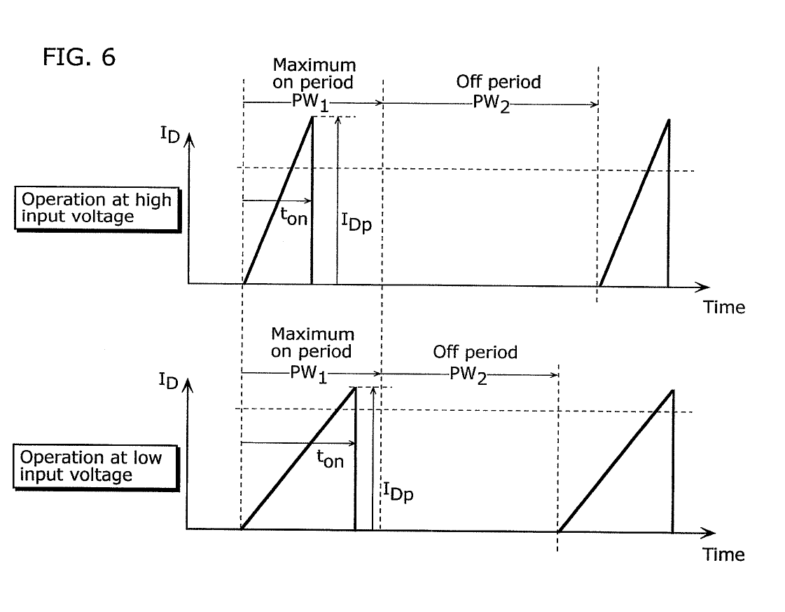

As shown in (A) and (B) of FIG. 6, the on period of the switching element 2 is shorter and thus the off period is longer when the input voltage is high than when the input voltage is low. As a result, the switching frequency decreases accordingly.

The energy P applied to the load is expressed by EQ. 6:

P=½×π×L×I_{Dp}²×f (EQ. 6),

where
π is efficiency;
L is an inductance of the transformer 1;
I_{Dp} is a peak current of the switching element 2; and
f is a switching frequency of the switching element 2.

As described in the Description of the Related Art above, since the peak current of the switching element 2 is larger when a switching power supply apparatus is operating at a high input voltage than at a low input voltage, energy supplied to the load may be too large when no adjustment is made for the off period.

In the switching power supply apparatus 100 operating at a high input voltage, the switching frequency is lowered with an extended minimum off period by taking advantage of a shorter on period tₒₙ of the switching element 2 than when operating at a low input voltage. Change in the energy P supplied to the load is thus reduced even when there is a change in the input voltage.

The switching power supply apparatus 100 performs such operation without changing a circuit constant. A switching power supply apparatus is thus provided in which change in current to a load depending on input voltage is small, advantageously allowing reduction in cost.

### Embodiment 2

The following describes a switching power supply apparatus 200 and a semiconductor device 204 used for control of the switching power supply apparatus 200 according to Embodiment 2 of the present invention.

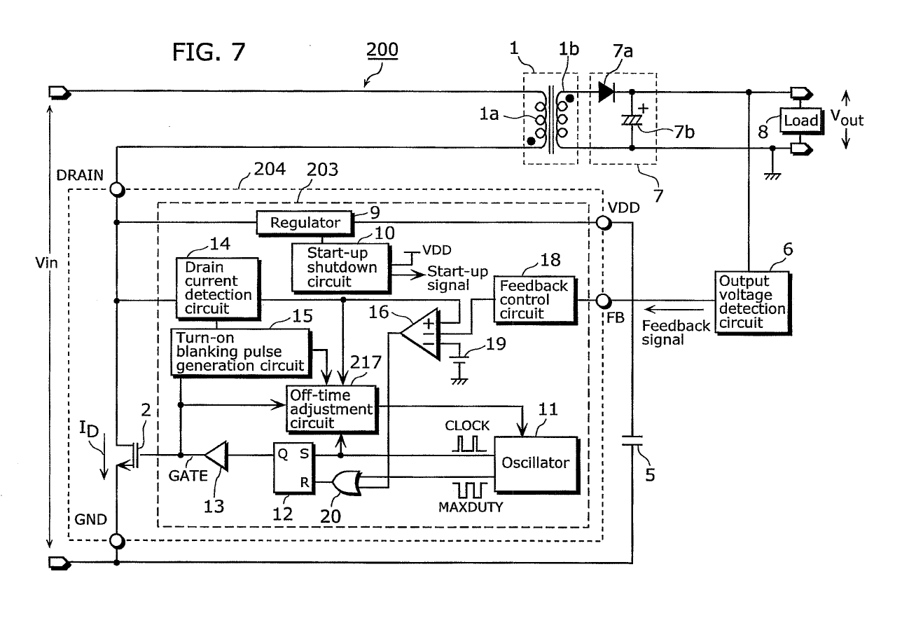

FIG. 7 is a functional block diagram which illustrates an exemplary configuration of the switching power supply apparatus 200 according to Embodiment 2.

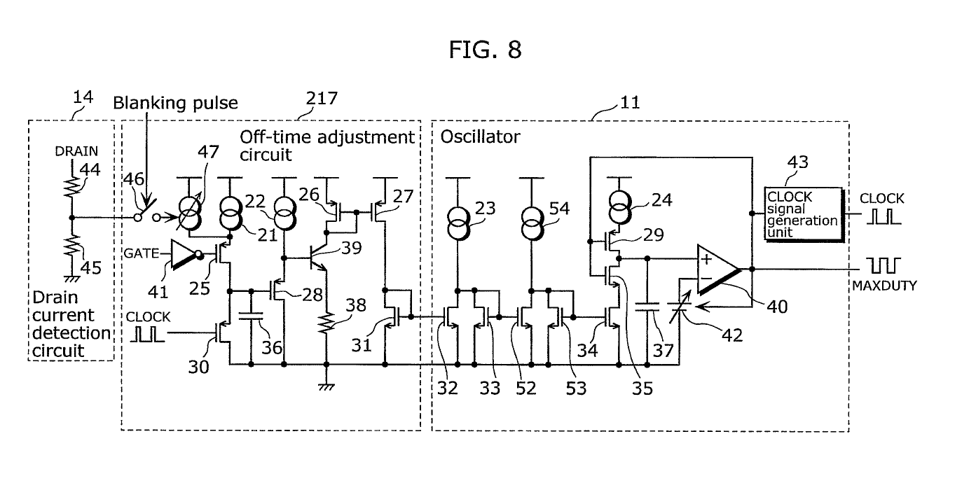

FIG. 8 is a circuit diagram which illustrates an exemplary configuration of an off-period adjustment circuit 217 and the oscillator 11 included in the semiconductor device 204.

The semiconductor device 204 differs from the semiconductor device 4 included in the switching power supply apparatus 100 according to Embodiment 1 in that the output of the drain current detection circuit 14 and an output of the turn-on blanking pulse generation circuit 15 are connected to the off-period adjustment circuit 217, and in that a variable current source 47 is connected in parallel with the constant current source 21 in the off-period adjustment circuit 217.

Since a structure and operation of the switching power supply apparatus 200 are generally the same as those described in Embodiment 1, the following describes only differences of Embodiment 2 from Embodiment 1.

In FIG. 8, the drain current detection circuit 14 is a shunt circuit including resistors 44 and 45. In comparison with the off-period adjustment circuit 17, the off-period adjustment circuit 217 additionally includes a switch 46 and a variable current source 47. The switch 46 has one end connected to the output of the drain current detection circuit 14 and the other end connected to the variable current source 47, and is turned on and off by blanking pulses provided from the turn-on blanking pulse generation circuit 15.

The turn-on blanking pulse generation circuit 15, for example, differentiates a MAXDUTY signal at a falling edge, so as to output a blanking pulse for a certain period of time immediately after the MAXDUTY signal indicates a maximum on period. The switch 46 is turned on by the blanking pulse, and then a current flowing through the variable current source 47 is determined by an output voltage of the drain current detection circuit 14 while the switch 46 is kept on by the blanking pulse.

The output voltage of the drain current detection circuit 14 while the blanking pulse is generated indicates a current residing in the primary winding 1a of the transformer 1 when the switching element 2 is turned on (the current is hereinafter referred to as a residual current). The variable current source 47 outputs, depending on the output voltage of the drain current detection circuit 14 when the blanking pulse is generated, a smaller current as the residual current is larger, and a larger current as the residual current is smaller.

The capacitor 36 is charged by a current from the variable current source 47 and a current from the constant current source 21. In comparison with Embodiment 1, the voltage across the capacitor 36 thus increases with increase in the current from the variable current source 47. The current flowing through the n-type MOSFET 34 changes through the operation which is similar to the operation in Embodiment 1 depending on the voltage across the capacitor 36 including the increase according to the current from the variable current source 47.

This is expressed by the equations below.

The voltage V₁ across the capacitor 36 is expressed by EQ. 7 in relation to on period tₒₙ of the switching element 2:

V₁=tₒₙ×(I_{const1}+Iᵥₐᵣ)/C₁ (EQ. 7),

where
C₁ is a capacity of the capacitor 36;
tₒₙ is a period from when the switching element 2 is turned on to when the switching element 2 is turned off;
I_{const1} is a current flowing from the constant current source 21; and
Iᵥₐᵣ is a current flowing through the variable current source 47.

The current I₂ of the n-type MOSFET 34 and the duration PW₂ of the off period which is indicated by the MAXDUTY signal at a high level are determined by EQ2, EQ, 3, and EQ. 5 as in Embodiment 1, using the voltage V₁ across the capacitor 36 expressed by EQ. 7.

In the switching power supply apparatus 200, the duration of the off period PW₂ changes depending not only on the on period tₒₙ of the switching element 2 but also on the current flowing through the switching element 2 when a blanking pulse is generated.

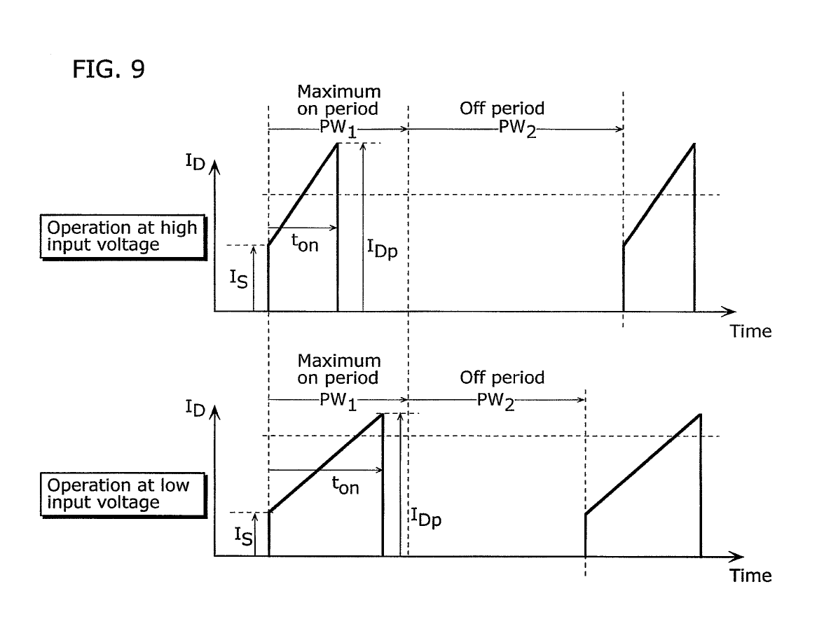

As shown in (A) and (B) of FIG. 9, if the switching element 2 is turned on when there is a current residing in the primary winding 1a of the transformer 1 (in other words, a residual current is present), the switching element 2 generates a drain current having the same value as the residual current Iₛ. Energy P to be applied to the load is expressed by EQ. 8.

P=½×π×L×(I_{Dp}²−Iₛ²)×f (EQ. 8),

where
π is efficiency;
L is an inductance of the transformer 1;
I_{Dp} is a peak current of the switching element 2;
Iₛ is a residual current when the switching element 2 is turned on; and
f is a switching frequency of the switching element 2.

EQ. 8 shows that the energy applied to the load decreases when the residual current Iₛ is large.

In the switching power supply apparatus 200, the current to be used for charging the capacitor 37 is changed to account for not only the on period tₒₙ of the switching element 2 but also the residual current Iₛ at the time when the switching element 2 is turned on. The residual current Iₛ is thus reduced by extending the off period of the switching element 2 in the case where the energy supplied to the load decreases because of the largeness of the residual current Iₛ, so that reduction in energy to be supplied is compensated.

The amount of energy to be supplied to the load thus is kept adequate to account for not only the input voltage but also the residual current Iₛ at the time of the turning-on.

### Embodiment 3

The following describes a switching power supply apparatus 300 and a semiconductor device 303 used for control of the switching power supply apparatus 300 according to Embodiment 3 of the present invention.

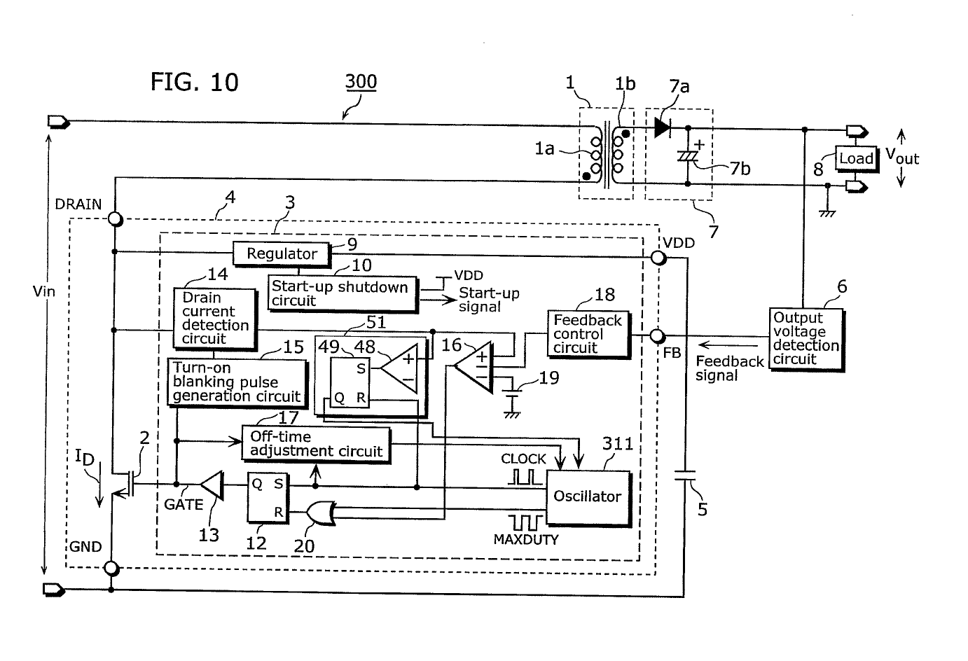

FIG. 10 is a functional block diagram which illustrates an exemplary configuration of the switching power supply apparatus 300 according to Embodiment 3.

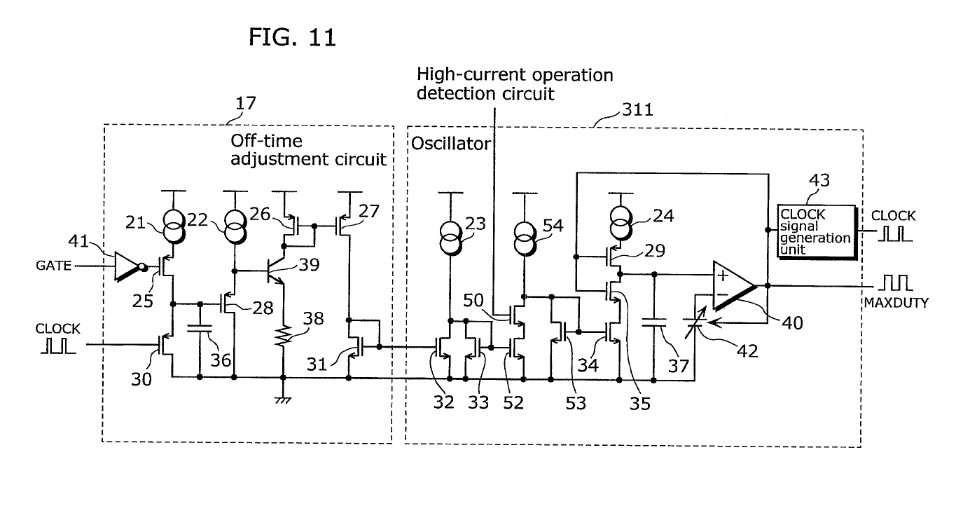

FIG. 11 is a circuit diagram which illustrates an exemplary configuration of the off-period adjustment circuit 17 and an oscillator 311 included in the semiconductor device 304.

The switching power supply apparatus 300 differs from the switching power supply apparatus 100 according to Embodiment 1 in that the semiconductor device 303 further includes a high-current operation detection circuit 51 which includes a comparator 48 and an RS flip-flop 49, and an oscillator 311 which further includes an n-type MOSFET 50.

Since a structure and operation of the switching power supply apparatus 300 are generally the same as those described in Embodiment 1, the following describes only differences of Embodiment 3 from Embodiment 1.

The drain current detection circuit 14 has an output connected to the positive input of the comparator 48. The reference voltage 19 is connected to one of the negative input of the comparator 48. The output of the comparator 48 is connected to the set input S of the RS flip-flop 49. The CLOCK signal is provided from the oscillator 311 to the reset input R of the RS flip-flop 49. The output Q of the RS flip-flop 49 is connected to a gate terminal of the n-type MOSFET 50 included in the oscillator 311.

When an output voltage of the drain current detection circuit 14 becomes higher than the reference voltage 19 while the switching element 2 is on, the output signal of the comparator 48 rises to a high level, and the output Q of the RS flip-flop 49 is set to a high level. The high-level output Q of the RS flip-flop 49 remains at the high level until the RS flip-flop 49 is reset by a next CLOCK signal even while the MAXDUTY signal indicates an off period, and turns on the n-type MOSFET 50 included in the oscillator 311.

When the output voltage of the drain current detection circuit 14 is lower than the reference voltage 19, that is, a feedback operation is performed, the output of the comparator 48 is at a low level, and thus the output Q of the RS flip-flop 49 decreases to a low level. This keeps the n-type MOSFET 50 included in the oscillator 311 off.

The off period of the switching element 2 is thus changed only while the switching element 2 is switching at a drain current determined by the reference voltage 19, so that deficiency in power supply due to change in frequency of the switching element 2 while a feedback operation is prevented by causing the operation of changing the off period of the switching element 2 to be performed only at a maximum power.

Although the switching element 2 and the control circuit 3 described above are provided on a single substrate, the control circuit 3 and the switching element 2 may be provided on different substrates.

### Embodiment 4

The following describes a switching power supply apparatus 400 and a semiconductor device 403 used for regulation of the switching power supply apparatus 400 according to Embodiment 4 of the present invention.

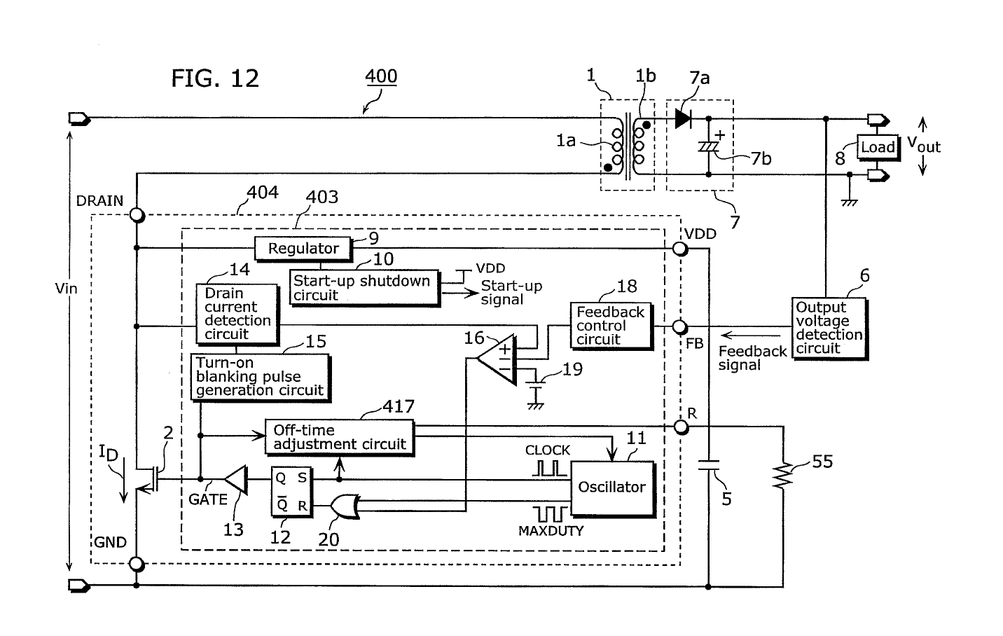

FIG. 12 is a functional block diagram which illustrates an exemplary configuration of the switching power supply apparatus 400 according to Embodiment 4.

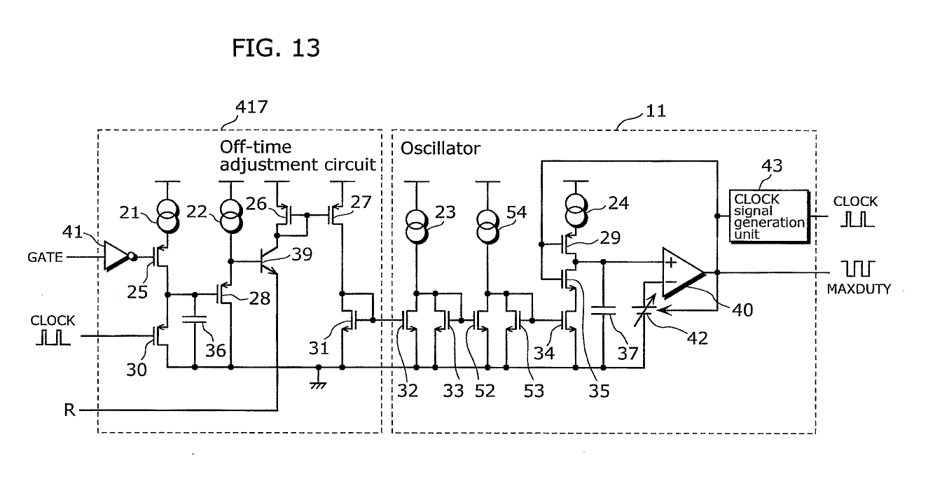

FIG. 13 is a circuit diagram which illustrates an exemplary configuration of an off-period adjustment circuit 417 and the oscillator 11 included in the semiconductor device 404.

Since a structure and operation of the switching power supply apparatus 400 are generally the same as those described in Embodiment 1, the following describes only differences of Embodiment 4 from Embodiment 1.

The switching power supply apparatus 400 differs from the switching power supply apparatus 100 according to Embodiment 1 in that the off-period adjustment circuit 417 included in the switching power supply apparatus 400 is not provided with the resistor 38 of the off-period adjustment circuit 17 (see FIG. 5), and in that a resistor 55 is connected externally to the semiconductor device 404.

The emitter terminal of the NPN bipolar transistor 39 included in the off-period adjustment circuit 417 is connected to the resistor 55 outside of the semiconductor device 404.

This configuration allows adjusting duration of an off period of the switching element 2 as necessary by changing resistance of the resistor 55.

Although the switching element 2 and the control circuit 3 are provided on a single substrate in this description, the control circuit 3 and the switching element 2 may be provided on different substrates.

Furthermore, although the switching power supply apparatus is described as an insulated power-supply circuit in which a transformer is used as a converter, the switching power supply apparatus may be a non-insulated power supply apparatus in which a coil is used as a converter.

These embodiments are described as examples of the present invention, and any circuit configured to perform the operation according to the present invention is included within the scope of the present invention.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

Among switching power supply apparatuses according to the present invention or semiconductor devices used therein, currents to loads are made uniform without providing different circuit constants according to a range of input voltages, thus cost of switching power supply apparatuses is can be reduced. The present invention is thus effectively applicable to switching power supply apparatuses such as an AC-AC converter and a DC-DC converter.

What is claimed is:

1. A semiconductor device comprising a control circuit which controls a switching power supply apparatus that converts an input direct current voltage into a regulated output direct current voltage,
wherein the switching power supply apparatus includes an output voltage detection circuit which detects a change in the output direct current voltage and transmits, to said control circuit, a feedback signal so that said control circuit controls switching operation which a switching element performs by supplying and blocking an input direct current voltage,
said control circuit includes:
an oscillator configured to determine a switching oscillation frequency of said switching element;
a feedback control circuit which determines, according to the feedback signal transmitted from the output voltage detection circuit, a level of a current to flow through said switching element;
a drain current detection circuit which outputs a voltage according to a current flowing through said switching element;
a comparator which generates a signal that causes said switching element to be turned off, when the voltage output by said drain current detection circuit reaches one of the level determined by said feedback control circuit and a reference voltage level; and
an off-period adjustment circuit which adjusts an off period based on a control signal to be provided to said switching element and an output signal provided from said oscillator, the off period being a period during which said switching element is kept in an off state, and
said control circuit changes the switching oscillation frequency by changing the off period of said switching element by causing said off-period adjustment circuit to change a period indicated as an off period of said switching element by a signal generated by said oscillator, according to a time which the current flowing through said switching element has taken to reach an overcurrent detection level after said switching element is kept in the off state during the adjusted off period.

2. The semiconductor device according to claim 1,
wherein a capacitor of said off-period adjustment circuit is charged by a constant current source during a period indicated as an on state of said switching element by a gate signal which causes said switching element to operate, said capacitor holds a voltage while the gate signal indicates an off state of said switching element, a current source is generated from the voltage, and a period indicated as an off state of said switching element by the gate signal is changed using a current from said current source.

3. The semiconductor device according to claim 1,
wherein said off-period adjustment circuit outputs an electrical signal according to duration of a period indicated as an on state of said switching element by a gate signal which causes said switching element to operate and a value of a residual current which is a current detected by said drain current detection circuit when said switching element enters the on state, and
said oscillator is configured to, according to the electrical signal, make a period indicated as the off state by the gate signal shorter as the period indicated as the on state by the gate signal is longer and the residual current is smaller, and makes a period indicated as the off state by the gate signal longer as the period indicated as the on state by the gate signal is shorter and the residual current is larger.

4. The semiconductor device according to claim 1, further comprising
a high-current operation detection circuit which detects a high-current operation performed when the current detected by said drain current detection circuit is larger than a predetermined reference value,
wherein said oscillator is configured to fix, regardless of the electrical signal, duration of a period indicated as the off state by the gate signal in the case where said high-current operation detection circuit detects the high-current operation.

5. The semiconductor device according to claim 1,
wherein said semiconductor device is controlled using a resistor in a circuit which generates the current source in said off-period adjustment circuit, and said resistor is provided outside of said semiconductor device so that the off period is adjusted as necessary by replacing said resistor with an other resistor.

6. A switching power supply apparatus comprising:
the semiconductor device according to claim 1;
a switching element provided in said semiconductor device;
a transformer which transforms an input alternating current voltage generated from an input direct current voltage into an output alternating current voltage by switching operation on the input alternating current voltage performed by said switching element; and
a smoothing circuit which converts the output alternating current voltage into the output direct current voltage.
